(19) United States
(12) Patent Application Publication
(10) Pub. No.: US 2008/0133308 A1
(43) Pub. Date: Jun. 5, 2008

(54) LEAKAGE LOCATION METHODS

(76) Inventor: James E. Harris, Indianapolis, IN (US)

Correspondence Address: BARNES & THORNBURG LLP, 11 SOUTH MERIDIAN, INDIANAPOLIS, IN, 46204, US

(21) Appl. No.: 11/943,950

(22) Filed: Nov. 21, 2007

Related U.S. Application Data
(60) Provisional application No. 60/861,164, filed on Nov. 27, 2006.
(60) Provisional application No. 60/878,918, filed on Jan. 5, 2007.

(51) Int. Cl. H04N 17/00; G01S 1/00; G06Q 10/00

(52) U.S. Cl. 705/9; 342/357.06; 705/1; 348/180

(57) ABSTRACT

A method is provided for locating the source of a leak from a CATV system. The method comprises providing at least one instrument adapted to measure the strength of a signal carried by the CATV system, moving the at least one instrument along a route, measuring the signal strength using the at least one instrument, providing Global Positioning System (GPS) locations to associate with measured signal strengths, storing the associated measured signal strengths and GPS locations, and identifying locations in the CATV system that lie along perpendiculars to the route at local maxima of the measured signal strength.

### CROSS REFERENCE TO RELATED APPLICATIONS

This regular utility patent application claims the benefit of the filing date of U.S. Ser. No. 60/861,164, titled “Leakage Testing Method And Apparatus,” filed Nov. 27, 2006. U.S. Ser. No. 60/861,164 is a related application to U.S. Ser. No. ______,filed______ , titled “Method For Displaying Leakage Location And Leakage Magnitude,” U.S. Ser. No. 60/878,918, filed Jan. 5, 2007, titled “Leakage Location Detection Method,” U.S. Ser. No. 11/742,184, titled “Leakage Location Methods,” filed Apr. 30, 2007, and U.S. Ser. No. 60/836,036, titled “Leakage Location Method,” filed Aug. 7, 2006. The complete disclosures of U.S. Ser. No. 60/878,918, U.S. Ser. No.______ ,U.S. Ser. No. 60/836,036, U.S. Ser. No. 60/861,164 and U.S. Ser. No. 11/742,184 are incorporated herein by reference.

### FIELD OF THE INVENTION

This invention relates to apparatus for making records concerning leakage from, for example, CATV cables, taps, fittings, drops and other CATV plant facilities, but it is believed to be useful in other applications as well.

### BACKGROUND OF THE INVENTION

Currently, CATV system operators fix known low-level leaks from their physical plants (that is, cable, splitters, line amplifiers, and so on) only when a technician happens to be passing through the neighborhood where the leak is known to exist on his/her way to or from another service call. Currently, each day, the dispatcher reviews a list of addresses of known low-level leaks and reviews the work orders his/her technicians will be servicing that day. Then, using a map, the dispatcher tries to estimate how close the various technicians will approach to any of the known leak sites as the technicians drive to the work order sites. Dispatchers complain that this a clumsy and ineffective process, especially when there are many tens of technicians, many work orders and many known leaks.

### DISCLOSURE OF THE INVENTION

According to an aspect of the invention, a method is provided for locating the source of a leak from a CATV system. The method comprises providing at least one instrument adapted to measure the strength of a signal carried by the CATV system, moving the at least one instrument along a route, measuring the signal strength using the at least one instrument, providing Global Positioning System (GPS) locations to associate with measured signal strengths, storing the associated measured signal strengths and GPS locations, and identifying locations in the CATV system that lie along perpendiculars to the route at local maxima of the measured signal strength.

Illustratively according to this aspect of the invention, the method further includes storing the thus-identified locations.

Illustratively according to this aspect of the invention, the method further includes scheduling CATV system components adjacent the locations for repair.

Illustratively according to this aspect of the invention, the method includes moving the at least one instrument along a second route, measuring the signal strength using the at least one instrument, providing GPS locations to the at least one instrument to associate with measured signal strengths, storing the associated measured signal strengths and GPS locations, and identifying locations in the CATV system that lie along intersections of perpendiculars to the route at local maxima of the measured signal strength and perpendiculars to the second route at local maxima of the measured signal strength.

Illustratively according to this aspect of the invention, the method further includes storing the thus-identified locations in the CATV system that lie along intersections of perpendiculars to the route at local maxima of the measured signal strength and perpendiculars to the second route at local maxima of the measured signal strength.

Illustratively according to this aspect of the invention, the method further includes scheduling CATV system components adjacent locations in the CATV system that lie along intersections of perpendiculars to the route at local maxima of the measured signal strength and perpendiculars to the second route at local maxima of the measured signal strength for repair.

According to another aspect of the invention, a method is provided for scheduling repairs to a CATV system. The method comprises determining perpendiculars from locations requiring repairs to routes traversed by CATV system repair personnel, calculating distances along the perpendiculars from the routes to the locations, and assigning repair personnel based upon the calculated distances.

According to an aspect of the invention, a method is provided for distribution of articles. The method comprises receiving from a first person a request for an article, determining the route being travelled by the first person, querying other routes to ascertain whether persons travelling those routes have the article, determining the routes being travelled by persons having the article, calculating the closest approach by a person having the article to the route of the first person, and arranging a rendezvous between the first person and the person having the article whose route most closely approaches the route of the first person.

Illustratively according to this aspect of the invention, the method further includes maintaining an inventory of the article in possession of the other persons. Querying other routes to ascertain whether persons travelling those routes have the article comprises querying the maintained inventories.

Illustratively according to the invention, storing the associated measured signal strengths and GPS locations comprises storing the associated measured signal strengths and GPS locations in memory provided in the instrument.

Illustratively according to the invention, the method further includes uploading the stored associated measured signal strengths and GPS locations to at least one processor and analyzing the uploaded associated measured signal strengths and GPS locations to generate plots of associated measured signal strengths and GPS locations.

Illustratively according to the invention, uploading the stored associated measured signal strengths and GPS locations to at least one processor comprises uploading the stored associated measured signal strengths and GPS locations to at least one processor at a hub or headend of the CATV system.

Illustratively according to the invention, providing GPS locations to associate with measured signal strengths comprises supplying GPS locations to the instrument through a port provided on the instrument from, for example, a separate commercially available GPS instrument.

Illustratively according to the invention, the method further includes calculating distances from the route to locations in the CATV system that lie along perpendiculars to the route at local maxima of the measured signal strength.

Illustratively according to the invention, identifying locations in the CATV system that lie along perpendiculars to the route at local maxima of the measured signal strength comprises converting locations in the CATV system that lie along perpendiculars to the route at local maxima of the measured signal strength into GPS coordinates.

Illustratively according to the invention, converting locations in the CATV system that lie along perpendiculars to the route at local maxima of the measured signal strength into GPS coordinates comprises converting locations in the CATV system that lie along perpendiculars to the route at local maxima of the measured signal strength into GPS coordinates using “reverse GPS” software.

Illustratively according to the invention, identifying locations in the CATV system that lie along perpendiculars to the route at local maxima of the measured signal strength comprises converting locations in the CATV system that lie along perpendiculars to the route at local maxima of the measured signal strength into addresses.

### BRIEF DESCRIPTION OF THE DRAWINGS

The invention may best be understood by referring to the following detailed description and accompanying drawings which illustrate the invention. In the drawings:

FIG. 1 highly diagrammatically illustrates equipment useful for performing the method of the present invention; and,

FIG. 2 illustrates the method for locating leaks according to the present invention.

### DEATILED DESCRIPTION OF ILLUSTRATIVE EMBODIMENTS

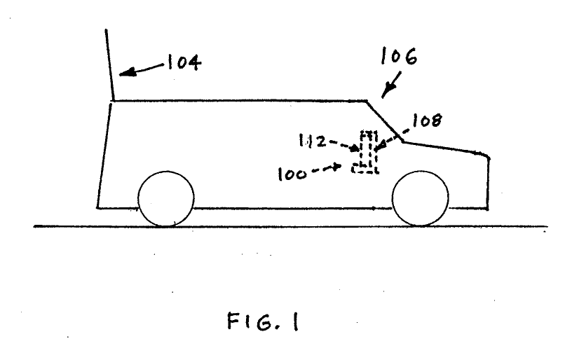

Referring now to FIG. 1, an instrument 100 is coupled to an antenna 104 mounted on a vehicle 106, illustratively, in a vehicle mobile mount 108. When the instrument 100 is in the mobile mount 108, instrument 100 illustratively is also coupled to a vehicle 106 audio system input. Instrument 100 illustratively is a Trilithic® Seeker™ leakage instrument, either GPS-capable (such as the Trilithic Seeker GPS) or coupled through a port provided for this purpose to a commercially available GPS instrument, such as one of the Garmin® or TomTom® GPS instruments capable of outputting GPS data in (a) standard format(s).

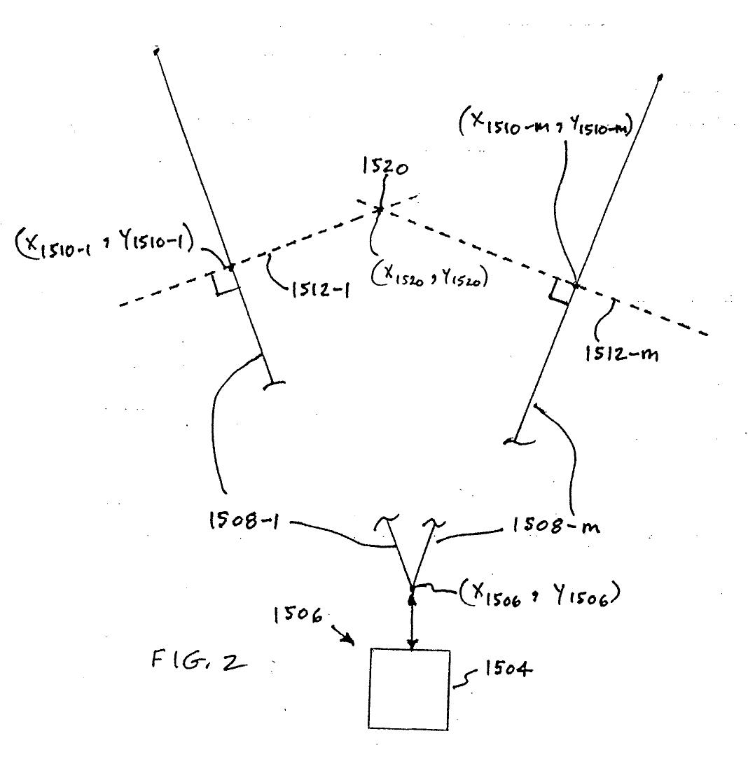

A technique for isolating the location of a leak using the system of the present invention is illustrated in FIG. 2. This technique may be implemented in situations in which multiple technicians or installers are on the road in vehicles 106 equipped with instruments 100. As the technicians drive to and from their assignments, the instruments 100 measure leakage signal strengths in predetermined frequency bands. These are stored along with the GPS locations where they are measured in memory provided in the instrument 100. The GPS locations are either provided by the instrument 100 or are supplied to the instrument 100 through a port provided on the instrument 100 from a separate commercially available GPS instrument (not shown). The stored data are uploaded to a processor 1504 at, for example, a hub or headend 1506. Illustratively, the coordinates (x₁₅₀₆, y₁₅₀₆), the origin of the route, may be a parking lot at the hub, headend or the like 1506. As the technicians drive along their routes 1508, the locations (x₁₅₁₀, y₁₅₁₀) of various detected leakage signal strength maxima on the various routes 1508 driven by the technicians are stored. One route 1508-1 will yield a line 1512-1 perpendicular to the route line 1508-1 along which the detected leakage signal strength is a maximum and intersecting the route line 1508-1 at (x₁₅₁₀₋₁, y₁₅₀₁₀₋₁), indicating that a leakage source 1520 is along the line 1512-1 in one direction or the other from route line 1508-1. However, as data are uploaded to the processor 1504 from additional different routes 1508-2, . . . 1508-m, . . . 1508-n, the location 1520 of the leak can be pinpointed with good accuracy from the intersections of such multiple lines 1512-1, . . . 1512-m, . . . 1512-n perpendicular to the multiple route lines 1508-1, . . . 1508-m,. . . 1508-n. The thus-pinpointed location 1520 may be stored and/or scheduled for repair.

This technique can be expanded. For example, a CATV system operator currently fixes a known low-level leak only when a technician happens to be passing through the neighborhood where the leak is known to exist on his way to or from another service call. Currently, each day, the dispatcher reviews a list of addresses of known low-level leaks and reviews the work orders his/her technicians will be servicing that day. Then, using a map, the dispatcher tries to estimate how close the various technicians will approach to any of the known leak sites as the technicians drive to the work order sites. Dispatchers complain that this a clumsy and ineffective process, especially when there are many tens of technicians, many work orders and many known leaks. For example, a dispatcher using route planning software has the ability to determine which of his fleet is likely to drive past a discretionary task site on his way to more important field work.

An expansion of the above technique is based upon relative GPS coordinates and straight line routes approximating the actual routes technicians take to their jobsites. In one implementation, the coordinates for the leaks would come from the database generated as described above. The GPS locations of the work order sites would be derived from an off-the-shelf reverse GPS application that would turn work order street addresses into GPS locations. The software uses analytic geometry to calculate how close each technician will get to every leak site in the course of driving his/her route. The results are converted to distances in miles which can be compared to settable distance limits. Vehicles and/or routes and the corresponding leaks meeting the maximum distance requirement would be highlighted. Work orders can be automatically generated for the technicians whose routes take them the closest to the reverse GPS addresses of the various leak sites.

The technician/vehicle/route selection function is adaptable to a variety of applications. For example, someone could call the CATV operator to report a pedestal (a CATV access point) left open at or near a particular address or location. This information would be relayed to the dispatcher, who would just put a work order on his/her discretionary list. In one implementation, similar calculations would compute how close two technicians/vehicles might pass each other. For example, a technician might have called in that he/she had used the last of his/her inventory of set top converters, and another technician/vehicle could be identified to meet the first technician/vehicle en route to resupply the first technician/vehicle from the second technician's/vehicle's inventory.

In the example illustrated in FIG. 2, let it be first assumed that the GPS location of leakage source 1520 (GPS coordinates x₁₅₂₀, y₁₅₂₀) has been established by the method described above. The various distances sqrt((x₁₅₂₀- x₁₅₁₀-m)^{2 +(Y}₁₅₂₀-y₁₅₁₀-m)²) can be calculated, and a route 1508-m producing the smallest sqrt((x₁₅₂₀-x₁₅₁₀-m)² +(y₁₅₂₀-y₁₅₁₀-m)²) to the given leakage site 1520 chosen. A work order may then automatically be generated for the technician who is driving that route 1508-m to visit and repair the leak.

What is claimed is:

1. A method for locating the source of a leak from a CATV system, the method comprising providing at least one instrument adapted to measure the strength of a signal carried by the CATV system, moving the at least one instrument along a route, measuring the signal strength using the at least one instrument, providing Global Positioning System (GPS) locations to associate with measured signal strengths, storing the associated measured signal strengths and GPS locations, and identifying locations in the CATV system that lie along perpendiculars to the route at local maxima of the measured signal strength.

2. The method of claim 1 further including storing the thus-identified locations.

3. The method of claim 1 further including scheduling CATV system components adjacent the locations for repair.

4. The method of claim 1 wherein storing the associated measured signal strengths and GPS locations comprises storing the associated measured signal strengths and GPS locations in memory provided in the instrument.

5. The method of claim 1 further including uploading the stored associated measured signal strengths and GPS locations to at least one processor and analyzing the uploaded associated measured signal strengths and GPS locations to generate plots of associated measured signal strengths and GPS locations.

6. The method of claim 5 wherein uploading the stored associated measured signal strengths and GPS locations to at least one processor comprises uploading the stored associated measured signal strengths and GPS locations to at least one processor at a hub or headend of the CATV system.

7. The method of claim 1 wherein providing GPS locations to associate with measured signal strengths comprises supplying GPS locations to the instrument through a port provided on the instrument.

8. The method of claim 1 further comprising calculating distances from the route to locations in the CATV system that lie along perpendiculars to the route at local maxima of the measured signal strength.

9. The method of claim 1 wherein identifying locations in the CATV system that lie along perpendiculars to the route at local maxima of the measured signal strength comprises converting locations in the CATV system that lie along perpendiculars to the route at local maxima of the measured signal strength into GPS coordinates.

10. The method of claim 9 further comprising calculating distances from the route to locations in the CATV system that lie along perpendiculars to the route at local maxima of the measured signal strength.

11. The method of claim 9 wherein converting locations in the CATV system that lie along perpendiculars to the route at local maxima of the measured signal strength into GPS coordinates comprises converting locations in the CATV system that lie along perpendiculars to the route at local maxima of the measured signal strength into GPS coordinates using reverse GPS.

12. The method of claim 11 further comprising calculating distances from the route to locations in the CATV system that lie along perpendiculars to the route at local maxima of the measured signal strength.

13. The method of claim 1 wherein identifying locations in the CATV system that lie along perpendiculars to the route at local maxima of the measured signal strength comprises converting locations in the CATV system that lie along perpendiculars to the route at local maxima of the measured signal strength into addresses.

14. The method of claim 13 further comprising calculating distances from the route to locations in the CATV system that lie along perpendiculars to the route at local maxima of the measured signal strength.

15. The method of claim 1 including moving the at least one instrument along a second route, measuring the signal strength using the at least one instrument, providing GPS locations to the at least one instrument to associate with measured signal strengths, storing the associated measured signal strengths and GPS locations, and identifying locations in the CATV system that lie along intersections of perpendiculars to the route at local maxima of the measured signal strength and perpendiculars to the second route at local maxima of the measured signal strength.

16. The method of claim 15 further including storing the thus-identified locations in the CATV system that lie along intersections of perpendiculars to the route at local maxima of the measured signal strength and perpendiculars to the second route at local maxima of the measured signal strength.

17. The method of claim 15 further including scheduling CATV system components adjacent locations in the CATV system that lie along intersections of perpendiculars to the route at local maxima of the measured signal strength and perpendiculars to the second route at local maxima of the measured signal strength for repair.

18. The method of claim 15 wherein storing the associated measured signal strengths and GPS locations comprises storing the associated measured signal strengths and GPS locations in memory provided in the instrument.

19. The method of claim 15 further including uploading the stored associated measured signal strengths and GPS locations to at least one processor, analyzing the associated measured signal strengths and GPS locations to generate plots of associated measured signal strengths and GPS locations comprising analyzing the uploaded associated measured signal strengths and GPS locations to generate plots of associated measured signal strengths and GPS locations.

20. The method of claim 19 wherein uploading the stored associated measured signal strengths and GPS locations to at least one processor comprises uploading the stored associated measured signal strengths and GPS locations to at least one processor at a hub or headend of the CATV system.

21. The method of claim 15 wherein providing GPS locations to associate with measured signal strengths comprises supplying GPS locations to the instrument through a port provided on the instrument.

22. The method of claim 15 further comprising calculating distances from the route to locations in the CATV system that lie along perpendiculars to the route at local maxima of the measured signal strength.

23. The method of claim 15 wherein identifying locations in the CATV system that lie along perpendiculars to the route at local maxima of the measured signal strength comprises converting locations in the CATV system that lie along perpendiculars to the route at local maxima of the measured signal strength into GPS coordinates.

24. The method of claim 23 further comprising calculating distances from the route to locations in the CATV system that lie along perpendiculars to the route at local maxima of the measured signal strength.

25. The method of claim 23 wherein converting locations in the CATV system that lie along perpendiculars to the route at local maxima of the measured signal strength into GPS coordinates comprises converting locations in the CATV system that lie along perpendiculars to the route at local maxima of the measured signal strength into GPS coordinates using reverse GPS.

26. The method of claim 25 further comprising calculating distances from the route to locations in the CATV system that lie along perpendiculars to the route at local maxima of the measured signal strength.

27. The method of claim 15 wherein identifying locations in the CATV system that lie along perpendiculars to the route at local maxima of the measured signal strength comprises converting locations in the CATV system that lie along perpendiculars to the route at local maxima of the measured signal strength into addresses.

28. The method of claim 27 further comprising calculating distances from the route to locations in the CATV system that lie along perpendiculars to the route at local maxima of the measured signal strength.

29. A method for scheduling repairs to a CATV system, the method comprising determining perpendiculars from locations requiring repairs to routes traversed by CATV system repair personnel, calculating distances along the perpendiculars from the routes to the locations, and assigning repair personnel based upon the calculated distances.

30. A method of distribution of articles, the method comprising receiving from a first person a request for an article, determining the route being travelled by the first person, querying other routes to ascertain whether persons travelling those routes have the article, determining the routes being travelled by persons having the article, calculating the closest approach by a person having the article to the route of the first person, and arranging a rendezvous between the first person and the person having the article whose route most closely approaches the route of the first person.

31. The method of claim 30 further including maintaining an inventory of the article in possession of each of the other persons, querying other routes to ascertain whether persons travelling those routes have the article comprising querying the maintained inventories.
